(19) United States
(12) Patent Application Publication
(10) Pub. No.: US 2024/0200482 A1
(43) Pub. Date: Jun. 20, 2024

(54) VEHICLE EXHAUST SYSTEM WITH END CAP MIXER

(71) Applicant: CUMMINS EMISSION SOLUTIONS INC., Columbus, IN (US)

(72) Inventors: Eduardo Alano, Columbus, IN (US); Pierre-Yves Hallier, Shanghai (CN); Ludovic Geant, Rioz (FR)

(73) Assignee: CUMMINS EMISSION SOLUTIONS INC., Columbus, IN (US)

(21) Appl. No.: 18/395,264

(22) Filed: Dec. 22, 2023

Related U.S. Application Data
(63) Continuation of application No. 16/914,591, filed on Jun. 29, 2020, now abandoned.

(51) Int. Cl. F01N 3/28; F01N 3/20

(52) U.S. Cl. CPC F01N 3/2821; F01N 3/2066; F01N 3/2892; F01N 2490/02; F01N 2610/085

(57) ABSTRACT

A vehicle exhaust system includes an upstream exhaust component comprising at least a first catalyst having a first outer dimension, a downstream exhaust component comprising at least a second catalyst having a second outer dimension, and a mixer that connects the upstream and downstream exhaust components. The mixer comprises a first portion associated with an outlet from the first catalyst and a second portion associated with an inlet to the second catalyst. The first portion includes a swirl component having a first length and the second portion includes an additional component having a second length. A connection interface between the first and second portions allows the upstream and downstream exhaust components to be arranged in different positions relative to each other. A combined length of the first and second lengths is adjusted relative to the first and second outer dimensions to achieve a desired position of the upstream and downstream exhaust components relative to each other.

### TECHNICAL FIELD

This disclosure relates generally to a mixer for a vehicle exhaust system.

### BACKGROUND

Vehicles include an exhaust system that has catalyst components to reduce emissions. In one example, an internal combustion engine directs hot engine exhaust gases into a diesel oxidation catalyst (DOC) that may additionally direct the exhaust gases into a diesel particulate filter (DPF). Downstream of the DOC and optional DPF is a selective catalytic reduction (SCR) catalyst. The exhaust system includes an injection system with an injector or doser that injects a diesel exhaust fluid (DEF), or a reducing agent such as a solution of urea and water for example, upstream of the SCR catalyst which is used to reduce NOx emissions. A mixer is positioned downstream of the DOC/DPF and upstream of the SCR and mixes the engine exhaust gases with products of urea transformation. The DOC/DPF and SCR can be arranged in various different configurations including inline and non-inline configurations dependent upon application and available packaging space. According to packaging arrangements, it is challenging to connect inline the DOC/DPF and SCR with the mixer to accommodate the different configurations.

### SUMMARY

A vehicle exhaust system, according to an exemplary aspect of the present disclosure includes, among other things, an upstream exhaust component comprising at least a first catalyst having a first outer dimension, a downstream exhaust component comprising at least a second catalyst having a second outer dimension, and a mixer that connects the upstream and downstream exhaust components. The mixer comprises a first portion associated with an outlet from the first catalyst and a second portion associated with an inlet to the second catalyst. The first portion includes a swirl component having a first length and the second portion includes an additional component having a second length. A connection interface between the first and second portions allows the upstream and downstream exhaust components to be arranged in different positions relative to each other. A combined length of the first and second lengths is adjusted relative to the first and second outer dimensions to achieve a desired position of the upstream and downstream exhaust components relative to each other.

In a further non-limiting embodiment of the foregoing system, the first portion comprises a first mixer housing portion, and including a doser opening formed in the first mixer housing portion that is configured to receive a doser to inject a fluid into the swirl component, and wherein the swirl component comprises a swirl chamber having an inlet associated with the doser and an outlet that directs a mixture of exhaust gas and injected fluid into the second portion.

In a further non-limiting embodiment of any of the foregoing systems, the second portion comprises a second mixer housing portion, and wherein the additional component comprises a perforated pipe that is enclosed within the second mixer housing portion.

In a further non-limiting embodiment of any of the foregoing systems, the perforated pipe comprises a straight pipe or has a trumpet shape.

In a further non-limiting embodiment of any of the foregoing systems, the perforated pipe comprises the straight pipe and has a first end open to the first portion and a second end that is closed by a solid concave surface provided by a bowl-shaped component.

In a further non-limiting embodiment of any of the foregoing systems, the second portion comprises a second mixer housing portion, and wherein the additional component comprises a non-perforated pipe that is enclosed within the second mixer housing portion, and wherein the non-perforated pipe comprises a straight pipe or has a trumpet shape.

In a further non-limiting embodiment of any of the foregoing systems, the non-perforated pipe comprises the straight pipe and has a first end open to the first portion and a second end that is closed by a bowl-shaped component that provides a solid concave surface for the second end, and wherein the bowl-shaped component includes a plurality of openings circumferentially spaced apart from each other about an outer wall of the bowl-shaped component.

In a further non-limiting embodiment of any of the foregoing systems, a baffle plate is positioned downstream of the additional component and upstream of the second catalyst.

In a further non-limiting embodiment of any of the foregoing systems, the connection interface comprises a direct connection between the first and second portions, or the connection interface comprises pipe sections selected from a group of: elbow pipe, straight pipe, flexible pipe.

In a further non-limiting embodiment of any of the foregoing systems, the upstream exhaust component defines a first center axis and the downstream exhaust component defines a second center axis, and wherein the combined length is smaller than the second outer dimension for an inline configuration where the first and second center axes are coaxial, and wherein the combined length is greater than the second outer dimension and smaller than a combined outer dimension of the first outer dimension added to the second outer dimension for a non-inline configuration where the first and second center axes are non-coaxial.

A vehicle exhaust system, according to yet another exemplary aspect of the present disclosure includes, among other things, an upstream exhaust component defining a first center axis and including at least a first catalyst having a first outermost dimension, a downstream exhaust component defining a second center axis and including at least a second catalyst having a second outermost dimension, and a mixer that connects the upstream and downstream exhaust components. The mixer comprises a first portion associated with an outlet from the first catalyst and a second portion associated with an inlet to the second catalyst. The first portion comprises a swirl component having a first length and enclosed within a first mixer housing, and the second portion comprises an additional component having a second length and enclosed within a second mixer housing. A connection interface between the first and second mixer housings allows the upstream and downstream exhaust components to be arranged in different positions relative to each other. The connection interface can comprise a direct connection or can include one or more additional connection components. A combined length of the first and second lengths is adjusted relative to the first and second outermost dimensions to achieve a desired position of the upstream and downstream exhaust components relative to each other.

In a further non-limiting embodiment of any of the foregoing systems, the swirl component comprises a swirl chamber with an increasing diameter and having an inlet associated with an injector and an outlet that directs a mixture of exhaust gas and injected fluid into the second portion, and wherein the additional component comprises a pipe that is enclosed within the second mixer housing portion.

In a further non-limiting embodiment of any of the foregoing systems, the pipe comprises a trumpet-shaped pipe or comprises a straight pipe having a first end open to the first portion and a second end that is closed by a bowl-shaped component that provides a solid concave surface at the second end.

In a further non-limiting embodiment of any of the foregoing systems, a baffle plate is positioned downstream of the pipe and upstream of the second catalyst.

In a further non-limiting embodiment of any of the foregoing systems, the one or more additional connection components comprises pipe sections selected from a group of: elbow pipe, straight pipe, flexible pipe.

In a further non-limiting embodiment of any of the foregoing systems, the combined length is smaller than the second outermost dimension for an inline configuration where the first and second center axes are coaxial, and wherein the combined length is greater than the second outermost dimension and smaller than a combined outer dimension of the first outermost dimension added to the second outermost dimension for a non-inline configuration where the first and second center axes are non-coaxial.

A method of assembling a mixer for a vehicle exhaust system according to still another exemplary aspect of the present disclosure includes, among other things: providing an upstream exhaust component defining a first center axis and including at least a first catalyst having a first outer dimension; providing a downstream exhaust component defining a second center axis and including at least a second catalyst having a second outer dimension; connecting the upstream and downstream exhaust components with a mixer, wherein the mixer comprises a first portion associated with an outlet from the first catalyst and a second portion associated with an inlet to the second catalyst, wherein the first portion includes a swirl component having a first length and enclosed within a first mixer housing, and the second portion includes an additional component having a second length and enclosed within a second mixer housing; providing a connection interface between the first and second mixer housings to allow the upstream and downstream exhaust components to be arranged in different positions relative to each other, and wherein the connection interface comprises either a direct connection between the first and second mixer housings or includes one or more additional pipe sections selected from a group of: elbow pipe, straight pipe, flexible pipe; and adjusting a combined length of the first and second lengths relative to the first and second outer dimensions such that the first and second center axes can be arranged to achieve a desired mounting configuration.

In a further non-limiting embodiment of the foregoing method, the swirl component comprises a swirl chamber with an increasing diameter and having an inlet associated with an injector and an outlet that directs a mixture of exhaust gas and injected fluid into the second portion, and wherein the additional component comprises a pipe that is enclosed within the second mixer housing portion, and including forming the pipe to have a first end open to the first portion and a second end that is closed by a bowl-shaped component that provides a solid concave surface.

In a further non-limiting embodiment of any of the foregoing methods, the additional component comprises a trumpet shaped pipe.

In a further non-limiting embodiment of any of the foregoing methods, the combined length is smaller than the second outer dimension for an inline configuration where the first and second center axes are coaxial, and wherein the combined length is greater than the second outer dimension and smaller than a combined outer dimension of the first outer dimension added to the second outer dimension for a non-inline configuration where the first and second center axes are non-coaxial.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates one example of a vehicle exhaust system with a mixer in an inline configuration.

FIG. 2 schematically illustrates one example of a vehicle exhaust system with a mixer in a non-inline configuration with a non-perforated internal component.

FIG. 3 is an end view showing internal components from the mixer of FIG. 2.

FIG. 4A is a perspective view of an inlet reactor as one of the internal components from FIG. 3.

FIG. 4B is an end view of the inlet reactor of FIG. 4A.

FIG. 5 is an end view showing the internal component for the mixer of FIG. 2 as a perforated component.

FIG. 6 schematically illustrates an example of the vehicle exhaust system with the internal component of FIG. 5.

FIG. 7 shows one example of a connection interface for a first mounting arrangement of a vehicle exhaust system.

FIG. 8 shows another example of a connection interface for a second mounting arrangement of a vehicle exhaust system.

FIG. 9 identifies dimensions for the internal components of the mixer and the upstream and downstream exhaust components.

FIG. 10A shows a side view of another internal component having a trumpet shape with perforations.

FIG. 10B shows an opposite side view of the internal component of FIG. 10A.

FIG. 10C is a perspective view of the internal component of FIG. 10A.

FIG. 11A shows a side view of another internal component that is a non-perforated trumpet.

FIG. 11B shows an opposite side view of the internal component of FIG. 11A.

FIG. 11C is a perspective view of the internal component of FIG. 11A.

FIG. 12A shows a view with a swirl chamber and a trumpet shaped component for the mixer.

FIG. 12B shows a non-perforated pipe and bowl configuration for the mixer.

### DETAILED DESCRIPTION

This disclosure details an exemplary mixer with first and second portions that can be directly connected or can be connected via a connection interface including additional connecting components to allow flexibility for different mounting configurations.

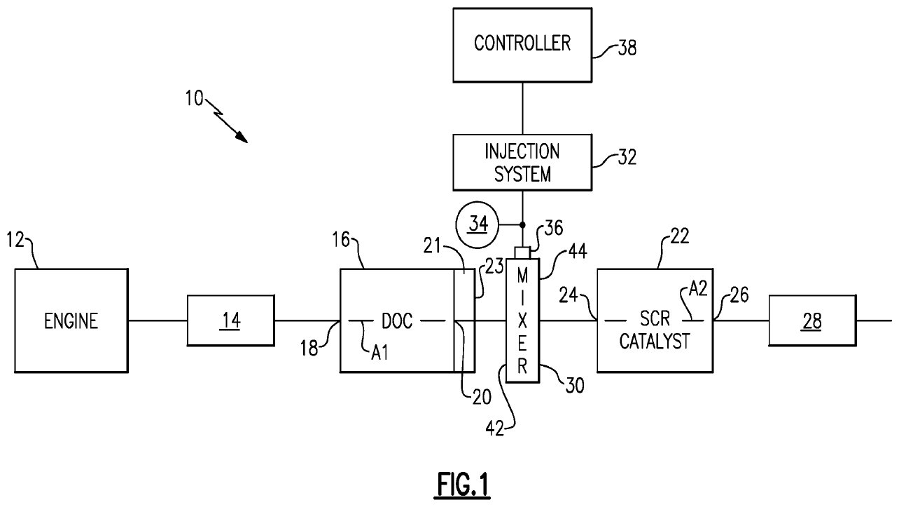

FIG. 1 shows a vehicle exhaust system 10 that conducts hot exhaust gases generated by an engine 12 through various upstream exhaust components 14 to reduce emission and control noise as known. In one example configuration, the upstream exhaust component 14 comprises at least one pipe that directs engine exhaust gases into a diesel oxidation catalyst (DOC) 16 having an inlet 18 and an outlet 20. Downstream of the DOC 16 there may be a diesel particulate filter (DPF) 21 that is used to remove contaminants from the exhaust gas as known. Downstream of the DOC 16 and optional DPF 21 is a selective catalytic reduction (SCR) catalyst 22 having an inlet 24 and an outlet 26. The outlet 26 communicates exhaust gases to downstream exhaust components 28, which eventually exhaust to atmosphere. Optionally, component 22 can comprise a catalyst that is configured to perform a selective catalytic reduction function and a particulate filter function. The various downstream exhaust components 28 can include one or more of the following: pipes, valves, catalysts, mufflers, tailpipes etc. These upstream 14 and downstream 28 components can be mounted in various different configurations and combinations dependent upon vehicle application and available packaging space.

In one example, a mixer 30 is positioned downstream from the outlet 20 of the DOC 16 or an outlet 23 of the DPF 21, and upstream of the inlet 24 of the SCR catalyst 22. The upstream catalyst and downstream catalyst can be in-line as shown in FIG. 1 or in parallel (non-inline) as shown in FIG. 2. The mixer 30 is used to generate a swirling or rotary motion of the exhaust gas.

An injection system 32 is used to inject a reducing agent, such as a solution of urea and water for example, into the exhaust gas stream upstream from the SCR catalyst 22 such that the mixer 30 can mix the urea and exhaust gas thoroughly together via a swirling generated flow. The injection system 32 includes a fluid supply 34, an injector/doser 36 defining a doser axis A, and a controller 38 that controls injection of the urea as known.

The mixer 30 has an inlet end 42 configured to receive the engine exhaust gases and an outlet end 44 to direct a mixture of swirling engine exhaust gas and products transformed from urea to the SCR catalyst 22. FIG. 2 shows one example of a mixer 30 that includes a first portion 46 and a second portion 48. The first portion 46 is at the upstream or inlet end 42 of the mixer 30. The first portion 46 is configured to initiate swirling of the exhaust gas flow through the mixer 30. The second portion 48 is at the downstream or outlet end 44 of the mixer 30. The second portion 48 distributes a mixture of exhaust gas and injected fluid in to the SCR 22. A connection interface 50 is used to connect the first portion 46 to the second portion 48. The connection interface 50 allows the DOC/DPF and SCR components to be arranged in different positions relative to each other. The exhaust gas flows from the first portion 46 to the second portion 48 via the connection interface 50. The connection interface 50 can comprise a direct connection or can include additional rigid members, flexible members, or a combination thereof.

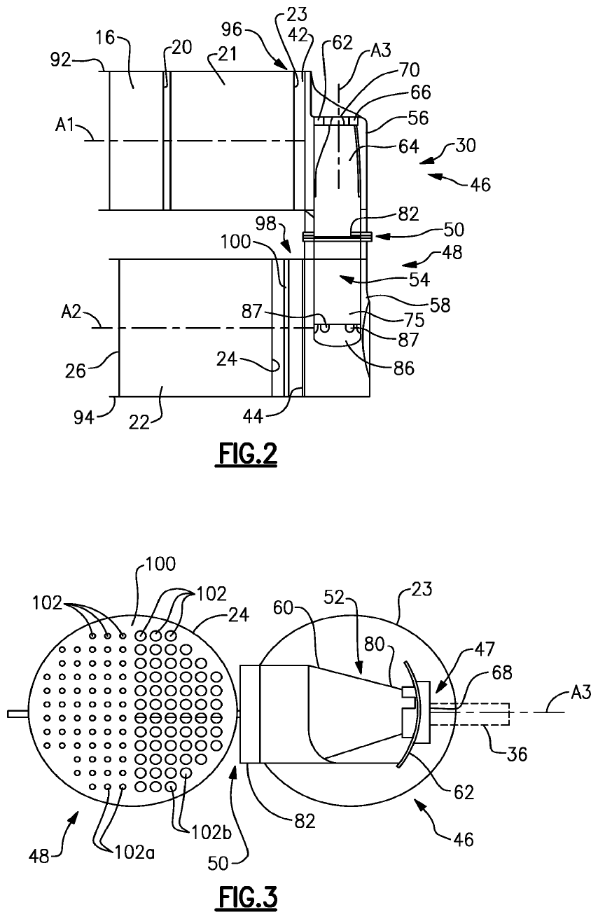

The first portion 46 is associated with the outlet 20 from the DOC or the outlet 23 from the DPF 21, and the second portion 48 is associated with the inlet 24 to the SCR 22. The first portion 46 includes a swirl component 52 (FIG. 3) and the second portion 48 includes a second component 54 (FIG. 5). The swirl component 52 is enclosed within an internal cavity provided by a first mixer housing 56 and the second component 54 is enclosed within an internal cavity provided by a second mixer housing 58. The connection interface 50 directly couples or connects the first mixer housing 56 to the second mixer housing 58.

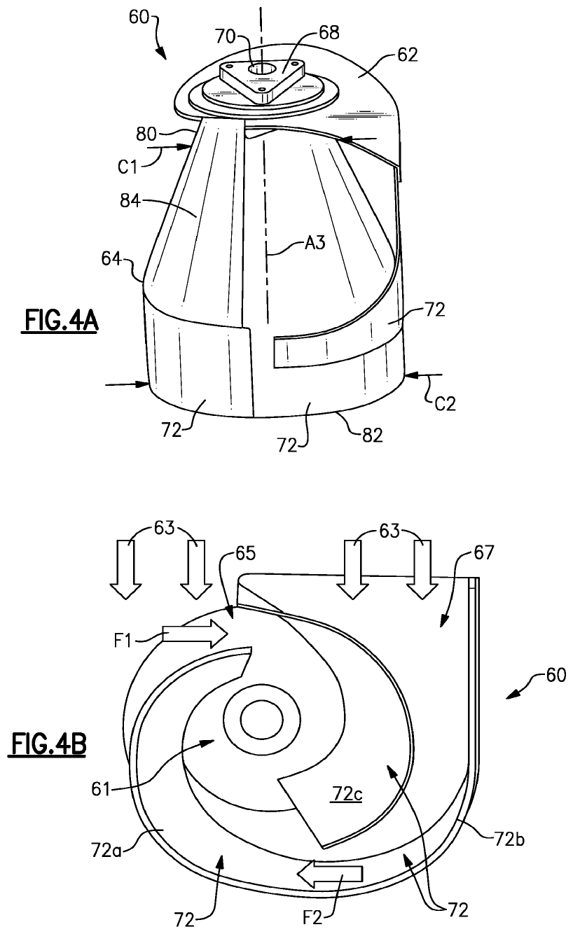

In one example shown in FIG. 3, the swirl component 52 comprises an inlet reactor 60 that is used to mount the injector/doser 36 relative to the first mixer housing 56. In one example shown in FIG. 4A, the inlet reactor 60 includes a doser mount 62 and a swirl chamber 64 that extends into the internal cavity of the first mixer housing 56. The doser mount 62 is mounted to the first mixer housing 56 at a doser opening 66 (FIG. 2) formed within the first mixer housing 56. The doser mount 62 is configured to support the doser 36 that injects a fluid into the internal cavity of the first mixer housing 56. In one example, the doser mount 62 comprises a curved body having a center boss 68 with a doser mount opening 70 defining a doser axis A3. In the example shown in FIG. 2, the doser axis A3 is orientated perpendicular to the first A1 and second A2 center axes.

The swirl chamber 64 has an upstream end 80 fixed to the doser mount 62 and a downstream end 82 that is open to the internal cavity within the first mixer housing 56. The upstream end 80 is defined by a first outer dimension C1 and the downstream end 82 is defined by a second outer dimension C2 that is greater than the first outer dimension C1 to form the chamber shape. In one example, the swirl chamber 64 has a constantly increasing outer dimension toward the downstream end 82 to provide a tapering body portion 84.

FIG. 4B shows an end view of the swirl chamber 64. In one example, the swirl chamber 64 is comprised of a plurality of flow elements 72 that are arranged and fixed together to form an internal mixing cavity 61. In one example, three flow elements 72a, 72b, and 72c are used to form the swirl chamber 64. Flow from upstream substrates/catalysts, indicated at 63, enters the mixing cavity 61 via two different flow passages. A first flow passage 65 is formed between flow elements 72a and 72c and a second flow passage 67 is formed between flow elements 72b and 72c. Flow F1 enters the first flow passage 65 in a first direction and is directed into the mixing cavity 61 along a curved portion of flow element 72c to generate a swirling motion. Flow F2 exits the second flow passage 67 in a second direction after being directed along a curved portion of flow element 72b to generate a swirling motion. In one example, the first and second directions are opposing. As such, exhaust gas enters the mixing cavity 61 from two discrete flow passages 65, 67 on opposite sides of the mixing chamber to create a swirling flow that is to mix with injected fluid.

The doser mount opening 70 of the doser mount 62 is positioned at the doser opening 66 of the first mixer housing 56. Fluid is injected through the aligned openings and into an interior of the swirl chamber 64 to mix with exhaust gas. The mixture of exhaust gas and fluid exits the downstream end 82 of the swirl chamber 64, and is then directed into the second mixer housing 58.

In one example, the plurality of flow elements 72 each have an upstream end fixed to the doser mount 62 and a downstream end. As discussed above, the plurality of flow elements 72 are attached to each other to form the swirl chamber 64. The inlet reactor 60 and swirl chamber 64 are described in greater detail in U.S. application Ser. No. 16/834,182 filed on Mar. 30, 2020, which is also assigned to the assignee of the present application and is hereby incorporated by reference.

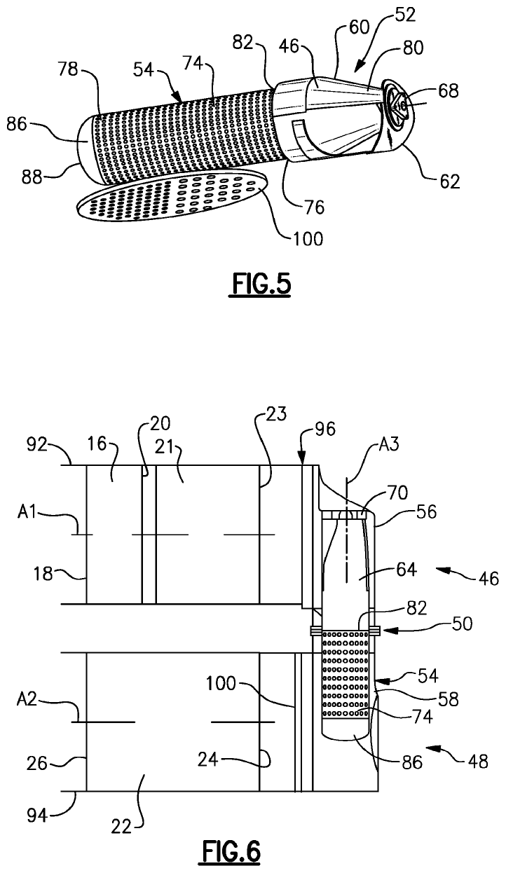

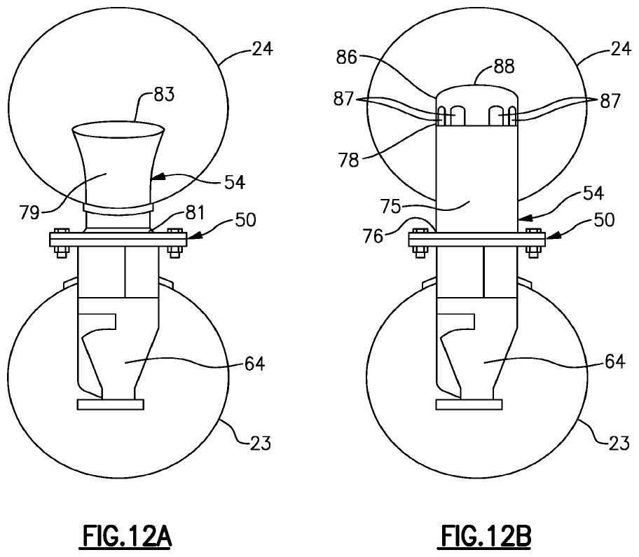

In one example shown in FIGS. 5-6, the component 54 comprises a perforated component such as a perforated pipe 74 that is enclosed within the second mixer housing 58. The perforated pipe 74 has a first end 76 open to the first portion 46 and a second end 78 that is closed by a solid surface as shown in FIG. 2. In another example, the second component 54 can comprise a non-perforated pipe 75 as shown in FIGS. 2 and 12B. In one example, the second ends 78 are at or near a center location of the second mixer housing 58 and/or adjacent to the second center axis A2.

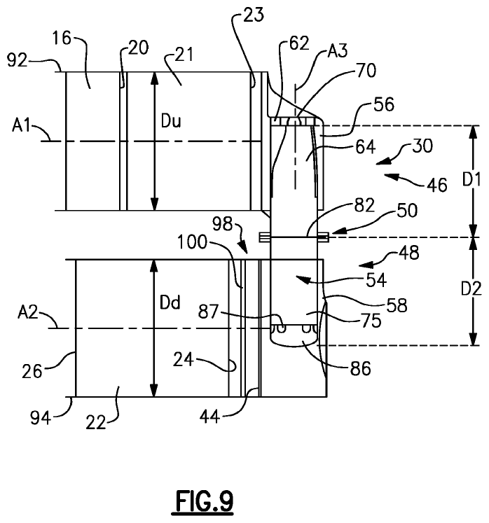

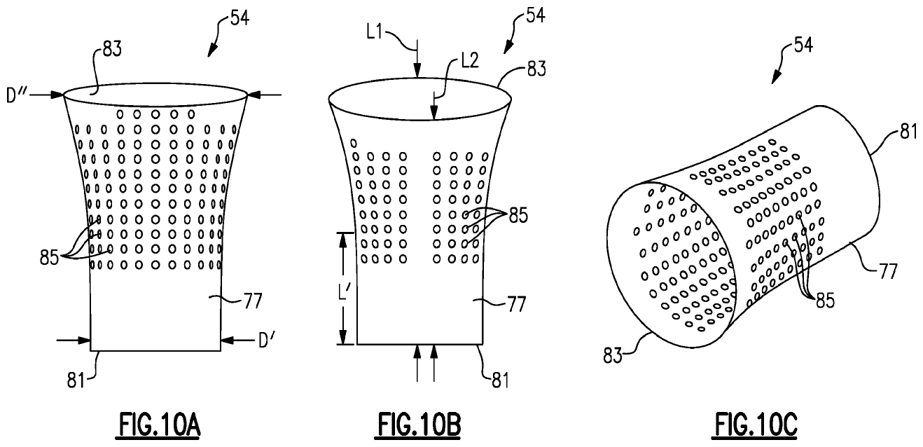

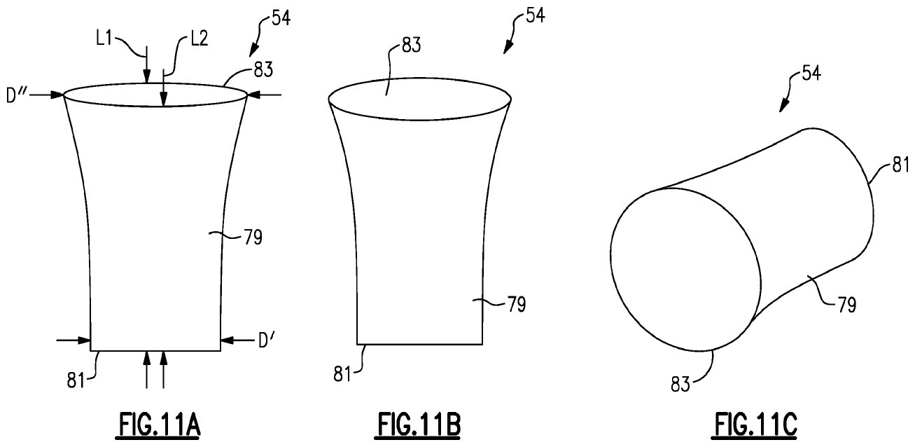

In another example, the second component 54 can comprise a perforated component such as a trumpet pipe 77 as shown in FIGS. 10A-10C. In another example, the second component 54 can comprise a non-perforated trumpet pipe 79 as shown in FIGS. 11A-11C. Each of these configurations has a first open end 81 that is open to the swirl chamber 64 and a second open end 83 that is open to the inlet 24 to the downstream exhaust component. The first open end 81 has a first diameter D′ and the second open end 83 has a second diameter D″ that is greater than the first diameter D′. The pipes 77, 79 have a generally constant diameter D′ starting from the first open end 81 and extending along an initial length L′, and then the diameter gradually increases from a termination of the initial length L′ to the second open end 83. This provides a tapered or flared end of the pipe 77, 79 to form the trumpet shape. In one example, the second open end 83 is at or near a center location of the second mixer housing 58 and/or adjacent to the second center axis A2.

In one example, the pipes 77, 79 have an axial length where one side has a greater length L1 than the length L2 of the opposite side (see FIGS. 10B and 11A). When installed in the mixer 30, the shorter side having the length L2 faces the inlet 24 to the downstream exhaust component (see FIG. 12A). This facilitates directing the swirling flow directly into and evenly across the inlet 24. FIG. 12A shows a configuration with the non-perforated trumpet pipe 79; however a perforated trumpet pipe 77 could also be used in this same configuration.

The perforated trumpet pipe 77 includes a plurality of openings 85 that extend circumferentially about the pipe 77 and extend along a length of the pipe 77. The openings 85 can have the same or different sizes, and can be arranged in different patterns. In one example, the first open end 81 has a first portion that is solid along a pipe length, i.e. does not have any openings, and then the openings 85 are provided from a termination of the solid potion to the second open end 83. The non-perforated trumpet pipe 79 has a solid surface along its entire length.

In one example, a bowl-shaped component 86 provides the solid surface of the closed end for the non-perforated second component 54 as a concave surface as shown in FIG. 2. FIG. 6 is similar to FIG. 2 but shows the second component 54 as a perforated pipe 74 with the bowl-shaped component 86. The bowl-shaped component 86 ensures that the mixture inside the second component 54 will not contact the second mixer housing 58. The second component 54 is hotter than the second mixer housing 58 and this offers improved deposit performance.

In one example, the bowl-shaped component 86 includes openings 87 as shown in FIGS. 2 and 12B. This configuration is used with the non-perforated pipe 75. In another example, the perforated pipe 74 is used with a bowl-shaped component 86 that does not include openings as shown in FIG. 6. Optionally, the bowl-shaped component 86 with openings 87 could also be used with the perforated pipe 74.

In one example, a first outer housing 92 surrounds the DOC 16 and DPF 21 and a second outer housing 94 surrounds the SCR 22. A first connection at 96 connects an outlet of the first outer housing 92 to the inlet end 42 of the mixer 30. A second connection at 98 connects the outlet end 44 of the mixer 30 to an inlet end of the second outer housing 94.

In one example, a baffle plate 100 is positioned at the outlet end 44 of the mixer 30 downstream of the perforated pipe 74 and upstream of the SCR 22 as shown in FIG. 6. In another example configuration, the baffle plate 100 can also be used with the second component 54 of FIG. 2 that comprises a non-perforated pipe 75. The baffle plate 100 could also be used with either trumpet configuration. In one example, the baffle plate 100 comprises a flat plate body with a plurality of openings 102. The openings 102 can be different sizes and/or shapes or can be the same size and shape. The openings 102 can also be arranged in different patterns as needed to achieve desired mixer performance. In one example, the baffle plate 100 includes a first half with a first set of openings 102a and a second half with a second set of openings 102b that are larger than the first set of openings 102a as shown in FIG. 3. In one example, the baffle plate 100 extends across the entire cross-section of the inlet 24 to the SCR 22 to thoroughly disperse the mixture of gas and spray prior to entering the SCR 22.

The connection interface 50 between the first 46 and second 48 portions allows the first outer housing 92 and the second outer housing 94 to be arranged in different positions relative to each other. The connection interface 50 can be a direct connection or can comprise pipe sections 104 that are elbow pipes, straight pipes, or flexible pipes. The pipe sections can be made from rigid or flexible material. The pipe sections 104 are selected in any of various combinations to provide the desired packaging arrangement.

For example, FIGS. 2 and 6 show a non-inline configuration where the first outer housing 92 is spaced apart (non-coaxial) and parallel to the second outer housing 94. In this example, the outlet from the DPF 21 and the inlet to the SCR 22 face the same direction and the first mixer housing 56 provides an end cap for the first outer housing 92, and the second mixer housing 58 provides an end cap for the second outer housing 94. The first 56 and second 58 mixer housings are closely coupled directly.

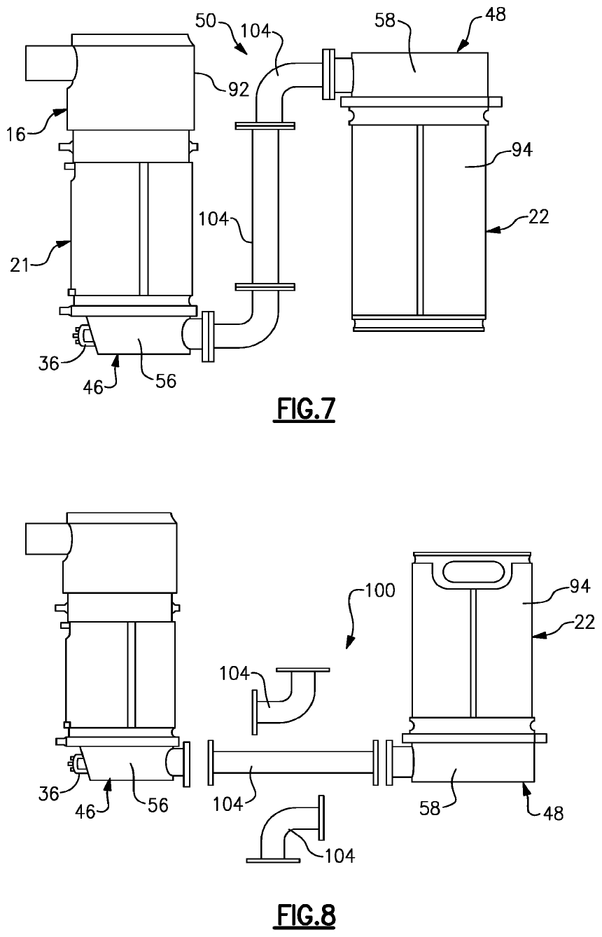

FIG. 8 shows a configuration similar to FIGS. 2 and 6; however, in this example, a longer straight pipe section 104 connects the first 56 and second 58 mixer housings. Additional elbow pipe sections 104 can be attached at either end of the straight pipe section as needed to achieve a different configuration such as that shown in FIG. 7. In this example, the outlet from the DPF 21 and the inlet to the SCR 22 face opposite directions and the first mixer housing 56 provides an end cap for the first outer housing 92, and the second mixer housing 58 provides an end cap for the second outer housing 94.

The subject disclosure provides for a configuration that achieves high SCR mixing performance in a non-inline configuration. The use of the reactor 60 with a swirl around the spray cone makes better use of the available space to spread out the droplets and reduce the local cooling effect that is generated by a localized impingement. According to substrate size, and to be more compact, the injector/doser 36 is at least partially recessed within the inlet substrate packaging (sec 47 in FIG. 3). The injector/doser 36 injects fluid into the flow path of the exhaust gas in the mixer 30 in a direction that is perpendicular to the flow path of the DOC/DPF 16/21.

The second portion 48 of the mixer 30 further comprises a catalyst inlet cone and a second component 54 that terminates in an outlet end that can be bounded by a substantially concave surface or which can be open. The connector interface 50 couples the first 46 and second 48 portions of the mixer 30 together. As such, the exhaust gas flows between the two portions of the mixer via the connector interface 50.

In one example shown in FIG. 9, the upstream catalyst has a diameter Du and the downstream catalyst has a diameter Dd. The swirling inlet reactor 60 extends along a first axial distance D1 and the second component 54 extends along a second axial distance D2. For an inline system, D1 plus D2 is smaller than Dd. For a non-inline system, D1 plus D2 is greater than Dd but smaller than Du plus Dd. In one example, the axial distance of the of the swirling inlet reactor 60 and second component 54 can be equivalent to a catalyst diameter to allow for an inline system. In another example, the axial distance of the of the swirling inlet reactor 60 and second component 54 can be approximately two times the catalyst diameter to allow the system to be assembled in a non-inline configuration with the first portion 46 and second portion 48 close coupled in a direct connection.

In the first portion 46, a majority of exhaust flow is collected by the swirling reactor 60 in order to generate a swirling mixture between exhaust and injected fluid. This swirling mixture reduces risk for deposits and extends through the axial length of the first 46 and second 48 portions. The exhaust gas from the DPF 21 will enter the first portion 46 of the mixer and the swirling chamber 64 inside the first portion 46 will spread injected fluid around swirling chamber. The fluid will be spread inside the inlet reactor 60, which is heated by flow coming from the upstream catalyst. This improves deposit performances by limiting cooling effect due to spray impingement.

The height of first portion 46 will depend on a maximum flowrate and injector spray angle. The pipe sections 104 between the first 46 and second 48 portions allow for a plurality of different configurations. Direct connection between the first 46 and second 48 portions via the pipe sections 104 uses a flange or clamp system, with potential different clocking of the sections to fit vehicle clearance space. Also, the housings 56, 58 can be welded together. The clocking can provide U-Shape, L-Shape, S-Shape, etc. configurations.

The second portion 48 is a radial inlet component providing good Flow Uniformity Index and fluid distribution at the SCR catalyst inlet surface. When exhaust flow reaches second portion 48, the perforated pipe 74 distributes the mixture to the SCR. The second portion 48 can have different shapes including a trumpet shape, for example. The perforated pipe 74 has the outlet closed by the bowl-shaped component 86 to collect droplets that have not been evaporated yet to protect catalyst from erosion and improve reductant conversion rate of the mixer. The bowl-shaped component 86 does not allow the mixture to be exposed to cooler temperatures present on the housing 58, which limits the cooling down effect due to the cold droplets and thus limits liquid film creation and improves deposit performances. If liquid happens to be created at a low temperature, the bowl-shaped component 86 will retain the liquid from entering the SCR. The external heated surface of the bowl reduces the cooling effect from impingement, thus reducing risk of deposit and liquid film accumulation. Adding the downstream baffle plate 100 improves Flow Uniformity Index and reductant distribution.

The subject disclosure provides an assembly where a combined length D1+D2 of the swirl inlet reactor 60 and the second component 54 is adjusted relative to the first Du and second Dd outermost dimensions of the substrates/catalysts of the upstream and downstream exhaust components to provide a desired mounting configuration. In one example, the combined length D1+D2 of the swirl inlet reactor 60 and the second component 54 is smaller than the outermost catalyst dimension Dd of the downstream exhaust component for an inline configuration where the first and second center axes of the upstream and downstream exhaust components are coaxial. In another example, the combined length D1+D2 of the swirl inlet reactor 60 and the second component 54 is greater than the outermost catalyst dimension Dd of the downstream exhaust component and smaller than a combined outermost catalyst dimension Du+Dd of the upstream and downstream exhaust components for a non-inline configuration where the first and second center axes are non-coaxial. This allows the same mixer structure, e.g. components 54 and 60, to be used for both inline and non-inline configurations simply by adjusting the length of the components.

Although a specific component relationship is illustrated in the figures of this disclosure, the illustrations are not intended to limit this disclosure. In other words, the placement and orientation of the various components shown could vary within the scope of this disclosure. In addition, the various figures accompanying this disclosure are not necessarily to scale, and some features may be exaggerated or minimized to show certain details of a particular component.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

1-20. (canceled)

21. An exhaust system comprising:
a mixer comprising:
a first portion at an inlet end of the mixer, the first portion comprising:
a first mixer housing defining a first internal cavity, the first mixer housing comprising a doser opening, and
a swirl component comprising an inlet reactor, the inlet reactor comprising:
a doser mount, and
a swirl chamber enclosed within the first internal cavity by the first mixer housing,
a second portion at an outlet end of the mixer, and
a connection interface connecting the first portion to the second portion; and
a doser coupled to the doser mount through the doser opening.

22. The exhaust system of claim 21, wherein the doser mount comprises:
a mount portion extending through the doser opening; and
a curved body comprising a body portion that is in confronting relation with a housing portion of the first mixer housing around the doser opening.

23. The exhaust system of claim 22, wherein the curved body further comprises a center boss with a doser mount opening defining a doser axis that extends into the first internal cavity, the center boss extending through the doser opening and coupled to the doser.

24. The exhaust system of claim 23, wherein the swirl chamber comprises:
an upstream end coupled to the doser mount, the upstream end defined by a first outer dimension; and
a downstream end that is open to the first internal cavity, the downstream end defined by a second outer dimension, the second outer dimension greater than the first outer dimension.

25. The exhaust system of claim 24, wherein the swirl chamber is tapered with a constantly increasing outer dimension toward the downstream end.

26. The exhaust system of claim 21, wherein the second portion comprises:
a second mixer housing defining a second internal cavity; and
a second component enclosed within the second internal cavity by the second mixer housing.

27. The exhaust system of claim 21, further comprising:
a diesel oxidation catalyst member having an outlet coupled to the first portion; and
a selective catalytic reduction catalyst member having an inlet coupled to the second portion.

28. The exhaust system of claim 21, further comprising:
a diesel particulate filter having an outlet coupled to the first portion; and
a selective catalytic reduction catalyst member having an inlet coupled to the second portion.

29. The exhaust system of claim 21, wherein the swirl chamber comprises a plurality of flow elements that are arranged and coupled together to form an internal mixing cavity.

30. The exhaust system of claim 29, wherein:
the flow elements comprise:
a first flow element,
a second flow element, and
a third flow element;
the first flow element and the second flow element define a first flow passage; and
the second flow element and the third flow element define a second flow passage.

31. The exhaust system of claim 30, wherein:
the first flow element comprises a first curved portion;
the second flow element comprises a second curved portion;
the third flow element comprises a third curved portion;
the first flow passage is defined between the first curved portion and the second curved portion; and
the second flow passage is defined between the second curved portion and the third curved portion.

32. The exhaust system of claim 21, wherein:
the second portion comprises a second mixer housing defining a second internal cavity; and
the mixer further comprises a perforated pipe that is enclosed within the second mixer housing, the perforated pipe comprising:
a first end that is open to the first portion, and
a second end that is closed by a solid surface.

33. The exhaust system of claim 21, wherein:
the second portion comprises a second mixer housing defining a second internal cavity; and
the mixer further comprises a perforated trumpet pipe that is enclosed within the second mixer housing, the perforated trumpet pipe comprising:
a first end that is open to the first portion, and
a second end that is open to the second portion.

34. The exhaust system of claim 33, wherein the perforated trumpet pipe comprises a plurality of perforates extending circumferentially around the perforated trumpet pipe and along a length of the perforated trumpet pipe.

35. The exhaust system of claim 34, further comprising a bowl-shaped component comprising:
a closed wall coupled to the second end, and
a closed end contiguous with the closed wall and separated from the non-perforated trumpet pipe by the closed wall, the closed end being concave when viewed from the perforated trumpet pipe.

36. The exhaust system of claim 21, wherein:
the second portion comprises a second mixer housing defining a second internal cavity; and
the mixer further comprises a non-perforated trumpet pipe that is enclosed within the second mixer housing, the non-perforated trumpet pipe comprising:
a first end that is open to the first portion, and
a second end that is open to the second portion.

37. The exhaust system of claim 36, further comprising a bowl-shaped component comprising:
a wall defining a plurality of bowl openings, the wall coupled to the second end, and
a closed end contiguous with the wall and separated from the non-perforated trumpet pipe by the wall, the closed end being concave when viewed from the non-perforated trumpet pipe.

38. The exhaust system of claim 21, wherein:
the second portion comprises a second mixer housing; and
the connection interface comprises:
a first elbow coupled to the first mixer housing;
a second elbow coupled to the second mixer housing; and
a straight or flexible pipe coupled to the first elbow and the second elbow.

39. The exhaust system of claim 21, wherein the mixer further comprises a baffle plate enclosed within the second portion, the baffle plate comprising a flat plate body with a plurality of openings.

40. The exhaust system of claim 39, wherein:
the flat plate body comprises a first half and a second half;
the openings comprise a first set of openings and a second set of openings;
each of the first set of openings is disposed on the first half and has a first diameter; and
each of the second set of openings is disposed on the second half and has a second diameter.
